(19) United States
(12) Patent Application Publication
(10) Pub. No.: US 2016/0226751 A1
(43) Pub. Date: Aug. 4, 2016

(54) SYSTEM, INFORMATION PROCESSING APPARATUS, AND METHOD

(71) Applicant: FUJITSU LIMITED, Kawasaki-shi (JP)

(72) Inventor: Koichiro YAMANA, San Jose, CA (US)

(73) Assignee: FUJITSU LIMITED, Kawasaki-shi (JP)

(21) Appl. No.: 15/092,716

(22) Filed: Apr. 7, 2016

Related U.S. Application Data
(63) Continuation of application No. PCT/JP2013/006849, filed on Nov. 21, 2013.

(51) Int. Cl. H04L 12/707; H04L 12/26; H04L 29/06

(52) U.S. Cl. CPC H04L 45/22; H04L 69/22; H04L 43/0823

(57) ABSTRACT

A system includes: a network switch configured to transfer a received packet; and an information processing apparatus including a communication interface circuit and a processor, the communication interface circuit being coupled to the network switch through a first communication path and a second communication path. The processor is configured to: transmit a first packet including a first payload to the network switch using the first communication path, transmit the second packet to the network switch using the second communication path, the second packet including a second payload of the second packet in which the same information as information recorded in the first payload of the first packet is recorded. An error detection is executed with regard to information respectively recorded in the first payload of the first packet and the second payload of the second packet.

### CROSS-REFERENCE TO RELATED APPLICATION

This application is a continuation application of International Application PCT/JP2013/006849 filed on Nov. 21, 2013 and designated the U.S., the entire contents of which are incorporated herein by reference.

### FIELD

The embodiments discussed herein are related to a system, an information processing apparatus, and a method.

### BACKGROUND

An information processing apparatus such as a server is connected to a network through a repeater hub or a network switch, and performs data packet transfer between the information processing apparatus itself and a different information processing apparatus. The repeater hub transfers a received packet to all the information processing apparatuses that are connected to the repeater hub. On the other hand, the network switch has a function of transmitting a packet to a specific information processing apparatus having an address according to the address that designates a destination recorded in a header portion of the packet.

A technology that relates to a connection between the information processing apparatus and the network switch and that makes a data transfer path redundant in order to increase reliability of data transmission is known. In the technology that makes the data transmission path redundant, multiple ports that are provided in the information processing apparatus and multiple ports that are provided in the network switch are connected to one another to configure an active system path and a standby system path. In a case where link-down occurs in the active system path or in a case where the rate of the occurrence of the error in the data transmission increases and thus quality of the data transmission decreases, a communication path is switched to the standby system path and the data communication is performed.

As an example of related art, Japanese Laid-open Patent Publication Nos. 5-145531, and 2006-180144 are known.

### SUMMARY

According to an aspect of the invention, a system includes: a network switch configured to transfer a received packet; and an information processing apparatus including a communication interface circuit and a processor, the communication interface circuit being coupled to the network switch through a first communication path and a second communication path. The processor is configured to: transmit a first packet including a first payload to the network switch using the first communication path, transmit the second packet to the network switch using the second communication path, the second packet including a second payload of the second packet in which the same information as information recorded in the first payload of the first packet is recorded, wherein an error detection is executed with regard to information respectively recorded in the first payload of the first packet and the second payload of the second packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an inter-apparatus connection relationship;

FIGS. 2A and 2B are diagrams for describing the fact that a rate of occurrence of an error can depend on a data pattern;

FIG. 3 is a diagram for describing the fact that the rate of the occurrence of the error can depend on the data pattern;

FIG. 4 is a diagram illustrating a hardware configuration of an information processing apparatus according to a first embodiment;

FIG. 5 is a diagram illustrating a connection relationship between an NIC and a network switch according to the first embodiment;

FIG. 6 is a diagram illustrating a hardware configuration of the NIC according to the first embodiment;

FIG. 7 is a functional block diagram of the NIC according to the first embodiment;

FIGS. 8A and 8B are diagrams illustrating a data configuration of a packet according to the first embodiment;

FIG. 9 is a diagram illustrating a hardware configuration of a network switch according to the first embodiment;

FIG. 10 is a functional block diagram illustrating the network switch according to the first embodiment;

FIG. 11 is a flowchart illustrating processing by the NIC according to the first embodiment;

FIG. 12 is a flowchart illustrating processing by the network switch according to the first embodiment;

FIG. 13 is a flowchart illustrating the processing by the NIC according to the first embodiment;

FIG. 14 is a functional block diagram illustrating an NIC according to a second embodiment;

FIG. 15 is a flowchart illustrating processing by the NIC according to the second embodiment;

FIG. 16 is a functional block diagram illustrating an NIC according to a third embodiment;

FIG. 17 is a flowchart illustrating processing by the NIC according to the third embodiment;

FIG. 18 is a flowchart illustrating the processing by the NIC according to the third embodiment;

FIG. 19 is a functional block diagram illustrating a network switch according to a fourth embodiment; and

FIG. 20 is a flowchart illustrating processing by the network switch according to the fourth embodiment.

### DESCRIPTION OF EMBODIMENTS

With regard to a method of switching between an active system path and a standby system path, in a technology in which in a case where a rate of occurrence of an error on the currently in-use system path increases a communication path is switched to the standby system path, it is difficult to guarantee that the path switching improves communication quality. This is because in some cases, the rate of the occurrence of the error on the standby system path can be greater than the rate of the occurrence of the error on the active system path.

In order to improve the communication quality by switching the communication path from the active system path to the standby system path, there is a demand to perform packet transmission using each of the paths and to compare the rates of the occurrence of the errors on both the communication paths. However, in some cases, the rate of the occurrence of the error is difficult to calculate by transmitting a packet along each of the paths and additionally it is difficult to precisely perform comparison of communication qualities.

An object of the present disclosure is to improve comparison precision in comparing the communication quality of the active system path and the standby system path.

An information processing apparatus and a network switch are connected to each other using the active system path and the standby system path, and then a packet is transmitted using the active system path and a packet that has in a payload the same information as in a payload of the packet which is transmitted using the active system path is transmitted using the standby system path. Then, the rates of the occurrence of the errors on both the communication paths are compared with each other and the switching between the communication paths is performed, thereby increasing the communication quality.

The present disclosure discloses a method in which a network interface card (hereinafter referred to as an “NIC”) that is installed in the information processing apparatus and the network switch are connected to each other and in which, in regards to the communication path having the active system path and the standby system path, the switching is performed between the active system path and the standby system path. In order to improve the communication quality by switching the communication path from the active system path from the standby system path, there is a demand to calculate each of the rate of the occurrence of the error on the active system path and the rate of the occurrence of the error on the standby system path and to compare both the rates with each other. For this reason, in the present disclosure, when performing the packet transmission using the active system path, the packet is sent not only along the active system path, but also along the standby system path. Then, the rate of the occurrence of the error on the active system path and the rate of the occurrence of the error on the standby system path are calculated based on data that is recorded in the payload of each of the packets that are transmitted along both the communication paths. In a case where, as a result of comparing the rates of the occurrence of the errors on both the communication paths, the rate of the occurrence of the error on the active system path is greater than the rate of the occurrence of the error on the standby system path, the switching between the active system path and the standby system path is performed. At this point, the inventor named in the present application found that a rate of occurrence of a data error could change due to contents of the data that was recorded in the payload of the packet which is transmitted. The payload indicates a data main body that results from excluding header information, such as a destination address, or a transmission source address, or trailer information, such as an error detection code or an error correction code, from the packet that is transmitted.

First, a packet communication environment and a data transfer method, which are targets of the present disclosure, are described, and the reason why the rates of the occurrence of the errors differ due to a data pattern that is transmitted, which was found by the inventor, is described.

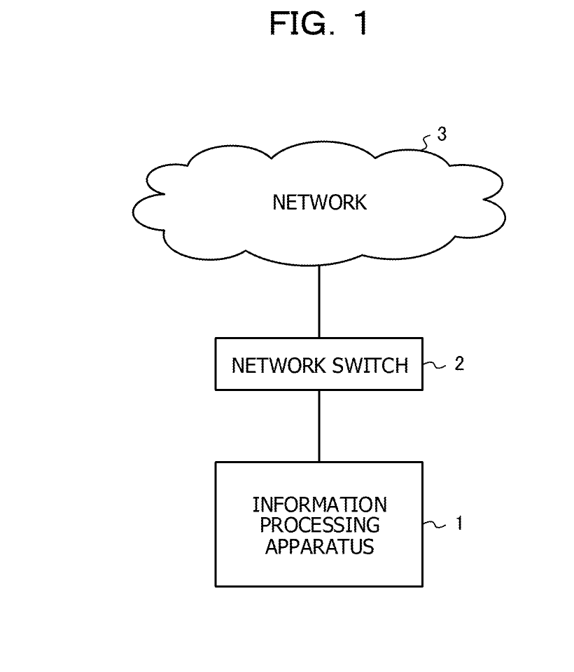

One example of data communication that is a target of the present disclosure is wired communication that uses a communication cable, such as a copper cable or an optical fiber, as a transfer medium. FIG. 1 illustrates an inter-apparatus connection relationship, and illustrates an information processing system that includes the network switch connection and the information processing apparatus. An information processing apparatus 1 is connected to a network switch 2, and the network switch 2 is connected to a network 3. The communication cable, such as the copper cable or the optical fiber, which is described above, is used for a connection between the information processing apparatus 1 and the network switch 2. The information processing apparatus 1 transmits the packet to the network switch 2. The packet includes the payload on which data has to be transmitted, the transmission source address that is an address of itself, and the destination address that specifies a data transmission destination. The transmission source address or the destination address is, for example, a MAC address of a port that is installed in the information processing apparatus 1 or an NIC of the information processing apparatus 1. The network switch 2 reads the destination address from the received packet, and transfers the packet to the designated destination address. The information processing apparatus 1 is, for example, a personal computer or a server, and the network switch 2 is, for example, the Ethernet (a registered trademark) switch.

The information processing apparatus 1 performs the data communication between the information processing apparatus 1 and the network switch 2, based on a baseband transfer scheme. A baseband transfer scheme is a method in which a digital signal that is a transmission target is transferred without performing modulation such as a frequency modulation. For example, in baseband transfer that uses the copper cable, the transmission side outputs and codes the digital signal into a potential signal according to a predetermined coding scheme, and outputs the coded potential signal. The receiving side reads a value of the received potential signal at a suitable timing, and thus reads the transmitted digital signal. As a coding scheme in the baseband transfer, for example, a non-return zero (NRZ) scheme is known. The NRZ scheme causes a low potential and a high potential to correspond to digital data “0” and digital data “1”, respectively, and outputs a pulse waveform that corresponds to a digital data sequence, on a channel.

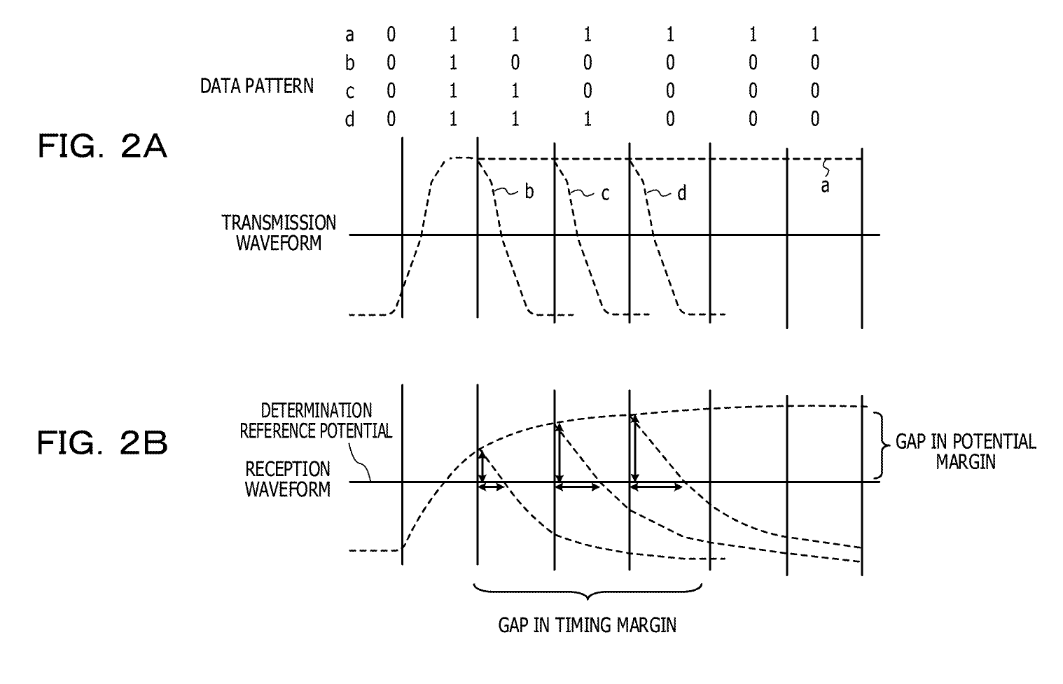

Next, as an example of the NRZ scheme, inter-code interference is described. The inter-code interference, in which adjacent codes mutually interfere with each other, is a phenomenon in which a pulse waveform is distorted on the channel, and is also referred to as “inter-symbol interference”. FIGS. 2A and 2B are diagrams for describing the fact that the rate of the occurrence of the error can depend on the data pattern. FIGS. 2A and 2B are diagrams for describing the inter-code interference, using as an example a case where several data patterns are coded with the NRZ scheme and are transferred. FIG. 2A illustrates a transmission waveform that results when data pattern a (0111111), data pattern b (0100000), data pattern c (0110000), and data pattern d (0111000) are coded with the NRZ scheme. FIG. 2B illustrates a reception waveform of a potential that is transferred over the communication and reaches the receiving side. As illustrated in FIG. 2B, corruption occurs in the reception waveform because of frequency characteristics of the channel. For this reason, it is understood that a potential amplitude of the reception waveform in the data pattern c is greater than a potential amplitude of the reception waveform in the data pattern b. Moreover, it is understood that a potential amplitude of the reception waveform in the data pattern d is greater than the potential amplitude of the reception waveform in the data pattern c. In this manner, the potential amplitude of the reception waveform can change depending on the data pattern. Furthermore, when focus is placed on a time interval from when the potential starts to decrease in the reception waveform to when the potential falls below a determination reference potential, it is understood that the time interval also differs due to the data pattern. This means that the broader the time interval, the greater a timing margin for correctly reading the digital data “1” is on the receiving side. To be more precise, it can be said that a timing margin that is allowed for the data pattern b is smaller than a timing margin that is allowed for the data pattern c, and that there is a high likelihood that a data reading error will occur due to lag in a determination timing. In other words, it is thought that the more transitions from the digital data “1” to the digital data “0” or the more transitions from the digital data “0” to the digital data “1” the data pattern includes, the higher the rate of the occurrence of the error tends to be.

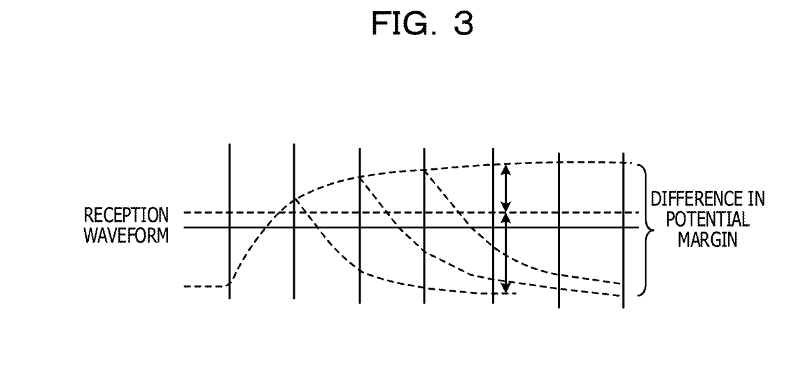

Furthermore, a case where a determination criterion value is shifted with respect to the reception waveform is also thought of as a reason that the rate of the occurrence of the error occurs due to the data pattern. FIG. 3 is a diagram for describing the fact that the rate of the occurrence of the error can depend on the data pattern, and illustrates a state where the determination criterion value is shifted to the extent of being greater than a predetermined value. This state, for example, can occur due to degradation in performance of a reference potential generation circuit that generates the determination reference potential. In a state that is illustrated in FIG. 3, due to a shift in the determination reference potential, a difference between the low potential that corresponds to the digital data “0” and the determination reference value increases and a potential margin increases as well. That is, even if potential noise occurs on the channel, the likelihood of the digital data “0” being erroneously determined as “1” decreases. In contrast, a difference between the high potential that corresponds to the digital data “1” and the determination reference value decreases and the potential margin decreases. Consequently, in a case where the potential noise occurs on the channel, the high likelihood of the digital data “1” being erroneously determined as “0” increases. In this case, it is thought that the more pieces of digital data “1” the data pattern includes, the higher the rate of the occurrence of the error tends to be.

In this manner, because in some cases, the rate of the occurrence of the error differs depending on the data pattern, in a case where transmission qualities of multiple transmission paths are compared with one another, it is preferred that data in the same pattern flows along each of the transmission paths and the rates of the occurrence of the error are compared with one another. Moreover, in FIGS. 2A, 2B, and 3, the NRZ coding scheme is described as an example, but in transmission that uses other coding schemes, for example, such as a return zero (RZ) scheme, an alternation mark inversion (AMI) scheme, a code mark inversion (CMI) scheme, and a Manchester scheme, because the dependence of the rate of the occurrence of the error due to the inter-code interference on the data pattern is present, it is preferred that, in performing the quality comparison of the transmission paths, the data in the same pattern is transmitted and the comparison of the rate of the occurrence of the error is performed.

For this reason, in the present disclosure, a first packet that has a first payload, and a second packet that has a second payload which contains the same contents as the first payload is prepared, the first packet is transmitted using the active system path, and the second packet is transmitted using the standby system path. Then, in the present disclosure, the rate of the occurrence of the error on the active system path is calculated based on the first payload, the rate of the occurrence of the error on the standby system path is calculated based on the second payload, and comparison of the communication qualities of both the communication paths is performed. In the present disclosure, the packet that is transmitted using the active system path is referred to as a transmission packet, and the packet that is transmitted using the standby system path is referred to as a duplicated packet.

Moreover, in FIGS. 2A, 2B, and 3, the wired communication that uses the communication cable is described as an example, but in some cases, the inter-code interference can occur due to analog characteristics or the like in a coding circuit of a reception apparatus or a composite circuit of the reception apparatus, in wireless communication as well. Thus, application of the present disclosure is possible.

### First Embodiment

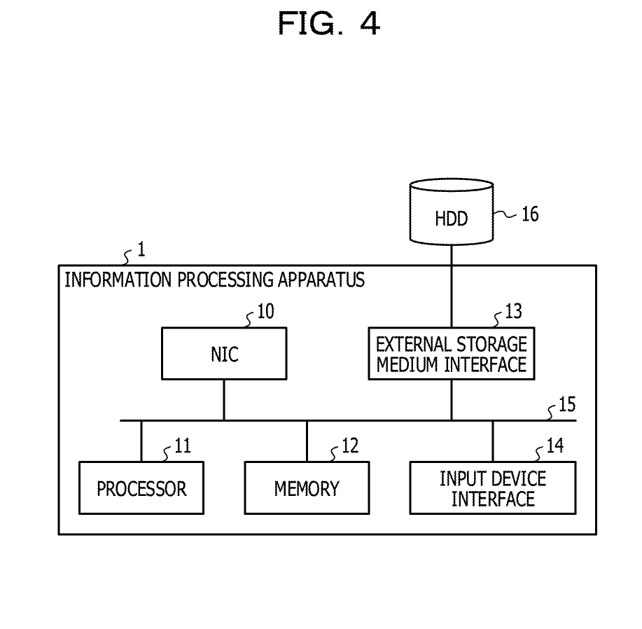

FIG. 4 is a diagram illustrating a hardware configuration of the information processing apparatus according to a first embodiment, and a diagram illustrating a hardware configuration of the information processing apparatus 1. The information processing apparatus 1 has an NIC 10, a processor 11, a memory 12, an external storage medium interface 13, an input device interface 14, and a bus 15 that mutually connects these to one another. The information processing apparatus 1 is connected to an external storage medium, such as an HDD 16, through the external storage medium interface 13. Furthermore, the information processing apparatus 1 is connected to the network switch 2 through the NIC 10. A connection between the NIC 10 and the network switch 2 will be described in detail below. The processor 11 is an electronic circuit component, such as a central processing unit (CPU), a micro-processing unit (MPU), a digital signal processor (DSP), or a field-programmable gate array (FPGA). The memory 12 is an electronic circuit component, such as a dynamic random access memory (DRAM), a static random access memory (SRAM), or a flash memory.

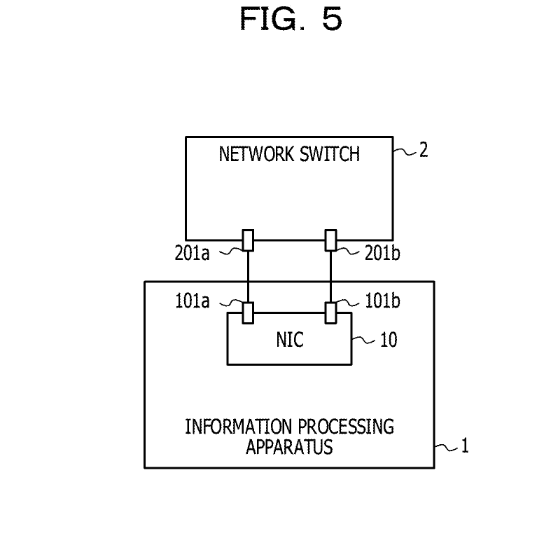

FIG. 5 illustrates a connection relationship between the NIC and the network switch according to the first embodiment, and illustrates a connection relationship between the network switch 2 and the NIC 10 that is installed in the information processing apparatus 1. The NIC 10 has a port A101a and a port B101b that are physically independent of each other. The network switch 2 has a port A′201a and a port B′201b that are physically independent of each other. A communication path A is configured by mutually connecting the port A101a and the port A′201a to each other, and a communication path B is configured by mutually connecting the port B101b and the port B′201b to each other. One of the communication path A and the communication path B is used as the active system path, and the other is used as the standby system path. Control of the communication path A and the communication path B is performed by a teaming driver that will be described below. Moreover, for easy description, in the present specification, unless specified otherwise, descriptions are provided on the assumption that the communication path A is controlled as the active system path and the communication path B is controlled as the standby system path.

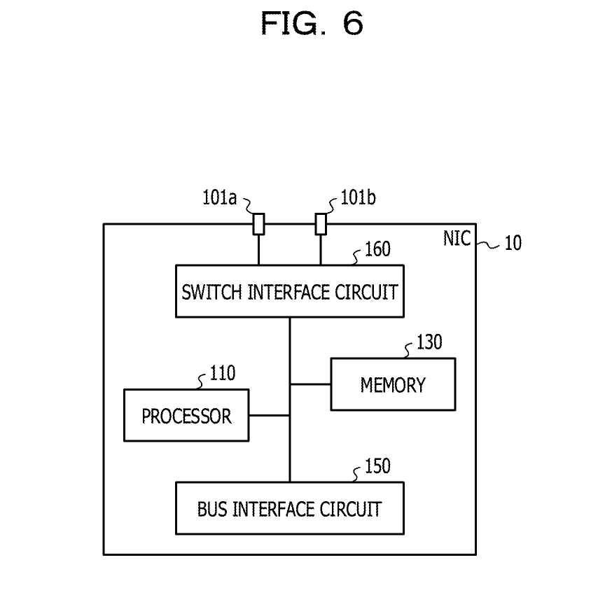

FIG. 6 is a diagram illustrating a hardware configuration of the NIC according to the first embodiment, and a diagram illustrating a hardware configuration of the NIC 10. The NIC 10 has a processor 110, a memory 130, a bus interface circuit 150 that is connected to the bus 15, and a switch interface circuit 160 that is connected to the network switch through the port A101a and the port B101b. Any one of the memory 130, the bus interface circuit 150, and the switch interface circuit 160 is connected to the processor 110. The processor 110 is an electronic circuit component, such as a CPU, an MPU, a DSP, or an FPGA. The memory 130 is an electronic circuit component, such as a DRAM, an SRAM, or a flash memory.

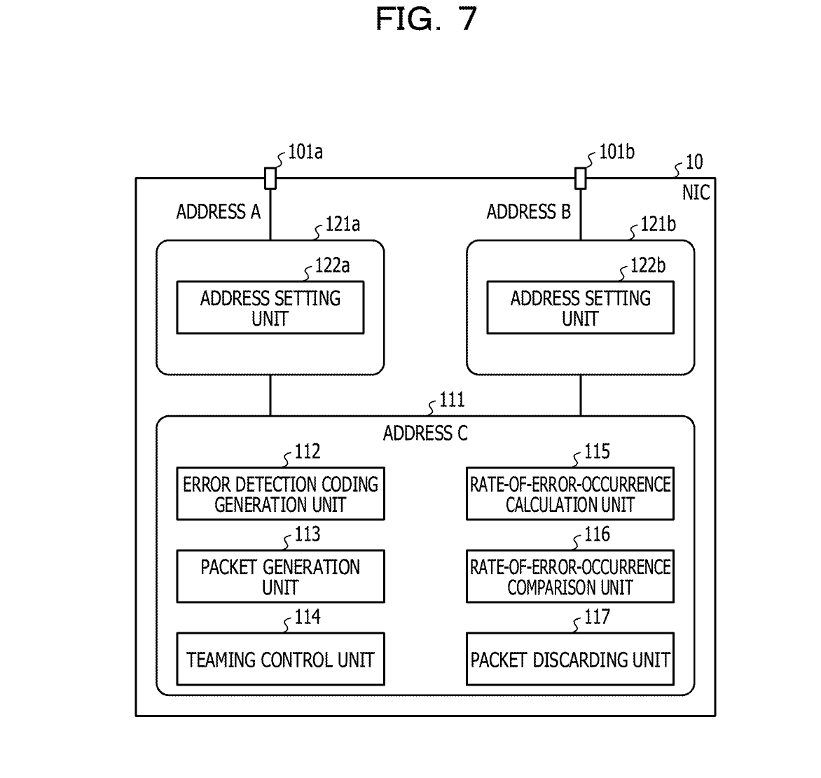

FIG. 7 is a functional block diagram illustrating the NIC according to the first embodiment, and a functional block diagram of the NIC 10. The processor 110 executes a predetermined program that is stored in the memory 130 or a different storage device that is accessible, and thus realizes each function that is illustrated in FIG. 5. The processor 110 functions as a teaming driver 111 that performs control that is common between the port A101a and the port B101b, and a device driver A121a and a device driver B121b that perform individual control on the port A101a and the port B101b, respectively. The teaming driver 111 functions as an error detection code generation unit 112, a packet generation unit 113, a teaming control unit 114, a rate-of-error-occurrence calculation unit 115, a rate-of-error-occurrence comparison unit 116, and a packet discarding unit 117. The error detection code generation unit 112 generates an error detection code for every packet that is transmitted, and adds the generated error detection code to the packet. The error detection code is, for example, a parity bit for performing parity check, a cyclic redundancy check (CRC) for performing cyclic redundancy check, or the like. Moreover, a code that makes it possible to perform error correction in addition to error detection is also included in the error detection code. The packet generation unit 113 generates the duplicated packet that has the payload which contains the same contents as those of the packet that is transmitted using the active system path. The teaming control unit 114 controls one of the communication path A that uses the port A101a and the communication path B that uses the port B101b, as the active system path for performing packet communication, and controls the other as the standby system path. In a state where the communication path A is controlled as the active system path and the communication path B is controlled as the standby system path, the teaming control unit 114 hands over the transmission packet to the device driver A121a, and hands over the duplicated packet to the device driver B121b. Furthermore, the teaming control unit 114 also performs switching control of the active system path and the standby system path based on the rate of the occurrence of the error on both the communication paths. The rate-of-error-occurrence calculation unit 115 acquires information on the number of packets that are received by the network switch 2 from the NIC 10 and on the number of packets in which an error is detected, among the received packets, from a number-of-erroneous-packets counter unit and a number-of-received-packets counter unit of the network switch 2, which will be described below, and calculates the rate of the occurrence of the error on both the communication paths. The rate-of-error-occurrence comparison unit 116 compares the rate of the occurrence of the error on the active system path and the rate of the occurrence of the error on the standby system path, which are calculated by the rate-of-error-occurrence calculation unit 115, with each other. The teaming control unit 114 performs the switching between the active system path and the standby system path based on a result of comparing the rates of the occurrence of the error on both the communication paths.

The device driver A121a and the device driver B121b have an address setting unit 122a and an address setting unit 122b, respectively. The address setting units 122a and 122b have a function of setting the transmission source address or the destination address that is included in the packet which is transmitted.

Moreover, an address A is allocated to the port A101a as the MAC address, and the address B is allocated to the port B101b as the MAC address. Furthermore, an address C is allocated to the teaming driver 111 as a virtual MAC address. The address C that is allocated to the teaming driver 111 is an address indicating the information processing apparatus 1, and, when performing the packet transmission with the information processing apparatus 1 as a destination, the address is designated as the destination address indicating a different information processing apparatus.

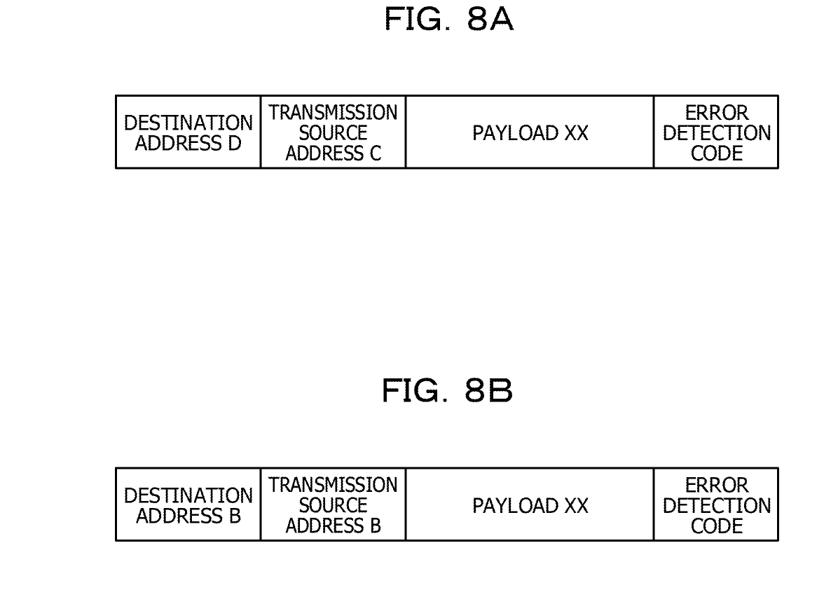

Next, operation of the NIC 10 in a case where the information processing apparatus 1 transfers a packet to a different information processing apparatus is described. FIGS. 8A and 8B are diagrams illustrating a packet data configuration according to the first embodiment. FIG. 8A illustrates a configuration of the transmission packet. The transmission packet includes a destination address indicating a transmission destination of a packet, a transmission source address indicating a transmission source of the packet, and a payload. According to the present embodiment, the destination address is assumed to be an address D that is an address of a different information processing apparatus, and the data in the payload is assumed to be XX. Furthermore, as the transmission source address, the address C that is the virtual MAC address which is attached to the teaming driver 111 is attached. The error detection code generation unit 112 generates the error detection code for performing the error detection on the data XX, and attaches the generated error detection code to the transmission packet. The teaming control unit 114 hands over the transmission packet that is illustrated in FIG. 8A to the device driver A121a that controls the port A101a.

The packet generation unit 113 generates the same payload as the transmission packet that is illustrated in FIG. 8A, and the duplicated packet that has the error detection code. The teaming control unit 114 hands over the duplicated packet to the device driver B121b that controls the port B101b. The address setting unit 122b of the device driver B121b sets the destination address of the duplicated packet to the address B that is the MAC address which is allocated to the port B101b. Furthermore, the address setting unit 122b of the device driver B121b also sets the transmission source address of the duplicated packet to the address B that is the MAC address which is allocated to the port B101b. The destination address is set to the address B in order for the duplicated packet not to flow into the network 3. When the duplicated packet flows from the network switch 2 into the network 3, this can become a cause of decreasing a transfer rate for transfer of a different packet. Furthermore, the transmission source address is set to the address B in order to make the network switch 2 learn the communication path. The learning of the communication path, which is performed by the network switch 2, will be described in detail below.

The device driver A121a transmits the transmission packet that is illustrated in FIG. 8A, to the network switch 2 through the port A101a. At this time, a device driver A101a transmits the transmission packet in a state where the address D is designated as the destination address and the address C is designated as the transmission source address, without changing the destination address and the transmission source address that are included in the transmission packet. Furthermore, the device driver B121b transmits the duplicated packet that is illustrated in FIG. 8B, to the network switch 2 through the port B101b.

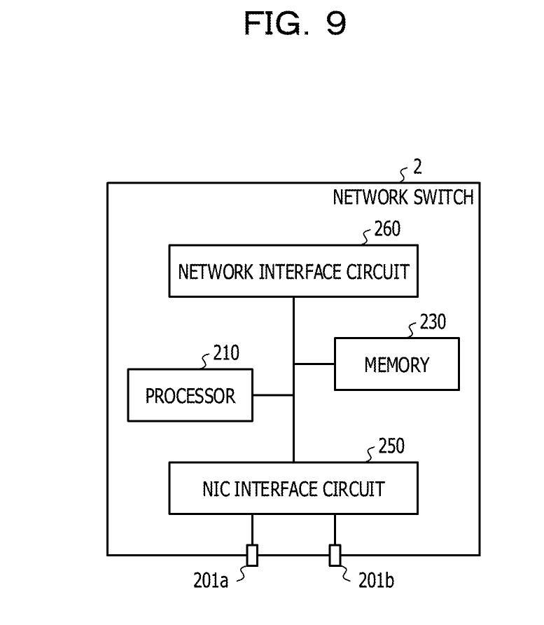

Next, a configuration and a function of the network switch 2 that receives the transmission packet and the duplicated packet are described. FIG. 9 is a diagram illustrating a hardware configuration of the network switch according to the first embodiment, and a diagram illustrating a hardware configuration of the network switch 2. The network switch 2 has a processor 210, a memory 230, an NIC interface circuit 250, and a network interface circuit 260 that is connected to the network 3. The NIC interface circuit 250 is connected to the port A′201a and the port B′201b. Any one of the memory 230, the NIC interface circuit 250, and the network interface circuit 260 is connected to the processor 210. The processor 210 is an electronic circuit component, such as a CPU, an MPU, a DSP, or an FPGA. The memory 230 is an electronic circuit component, such as a DRAM, an SRAM, or a flash memory.

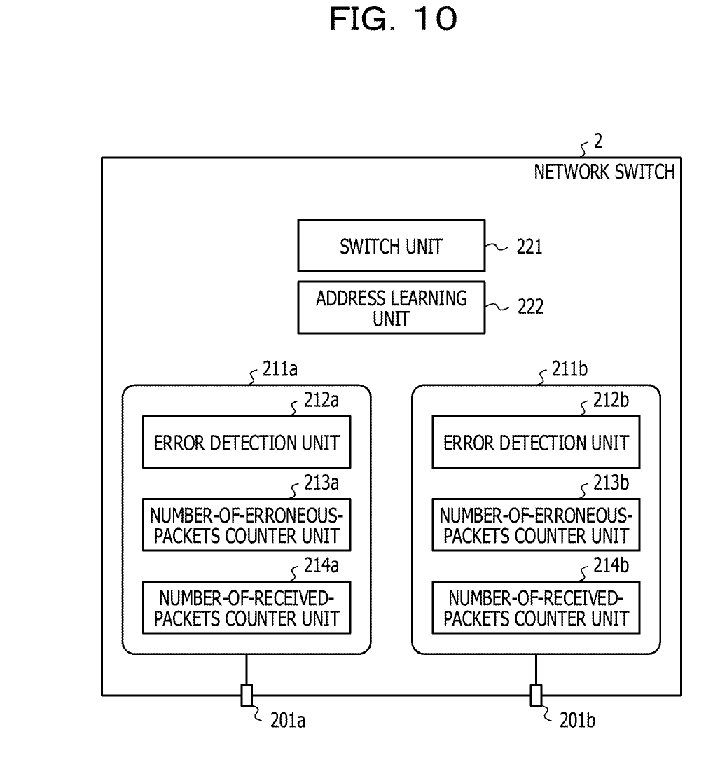

FIG. 10 is a functional block diagram illustrating the network switch according to the first embodiment, and a functional block diagram illustrating the network switch 2. The processor 210 executes a predetermined program that is stored in the memory 230 or a different storage medium that is accessible, and thus realizes each function that is illustrated in FIG. 10. The processor 210 functions as a device driver A′211a that is installed for the port A′201a, and a device driver B′211b, a switch unit 221, and an address learning unit 222 that are installed for the port B′201b. Each of the device driver A′211a and the device driver B′211b functions as error detection units 212a and 212b, number-of-erroneous packets counter units 213a and 213b, and number-of-received-packets counter units 214a and 214b. The error detection units 212a and 212b perform error detection using the error detection code that is included in the packet which is received from the NIC 10. The number-of-erroneous packets counter units 213a and 213b count the number of packets in which the error is detected by the error detection units 212a and 212b. The number-of-received-packets counter units 214a and 214b count the number of packets that are received by the NIC 10. The switch unit 221 reads the destination address of the received packet, and transfers the packet to the designated address. For example, the transmission packet that is illustrated in FIG. 8A is transferred to a different information processing apparatus that has the address D in the switch unit 221, and the duplicated packet that is illustrated in FIG. 8B is transferred back to the port B101b. The address learning unit 222 has a function of learning the transmission source address of the received packet for each of the port A′201a and the port B′201b. For example, the address learning unit 222 learns that the port A′201a is connected to the information processing apparatus 1 that is indicated by the address C, based on the fact that the transmission source address of the transmission packet which is received in the port A′201a is the address C. On the other hand, the address learning unit 222 learns that the port B′201b is connected to the port B101b, based on the fact that the transmission source address of the duplicated packet which is received in the port B′201b is the address B. However, this means that, when the port B′201b is connected to a node, that is, the information processing apparatus 1, which is specified by the address C, the address learning unit 222 has difficulty in performing recognition. In this state, it is assumed that the network switch 2 receives a packet that is sent with the information processing apparatus 1 as a destination, that is, a packet in which the address C is designated as the destination address, from a different information processing apparatus. In this case, because the network switch 2 recognizes that the packet in which the address C is designated as the destination is a packet that has to be sent to the port A′201a, based on a result of the learning by the address learning unit 222, the network switch 2 can transfer that packet to the information processing apparatus 1 using an active system path A. Moreover, the network switch 2 may be realized using a logic circuit dedicated for a function that is illustrated in FIG. 10.

Next, a method of calculating the rate of the occurrence of the error on each communication path is described. The rate of the occurrence of the error is defined as a ratio of the number of packets in which the error is detected to the total number of packets that are received by the network switch 2. A rate ER_A of the occurrence of the error on the communication path A and a rate ER_B of the occurrence of the error on the communication path B are expressed by the following Equation (1) and Equation (2), where the total number of packets that are transmitted from the NIC 10 using the communication path A is rxA, the number of packets in which the error is detected among the packets that are transmitted along the communication path A is crcA, the total number of packets that are transmitted from the NIC 10 using the communication path B is rxB, and the number of packets in which the error is detected among the packets that are transmitted along the communication path B is crcB.

ER_A=crcA/rxA (1)

ER_B=crcB/rxB (2)

The rate-of-error-occurrence calculation unit 115 of the NIC 10 acquires the total numbers rxA and rxB of packets from the number-of-received-packets counter units 214a and 214b, respectively, of the network switch 2, acquires the numbers crcA and crcB of packets from the number-of-erroneous packets counter units 213a and 213b, respectively, of the network switch 2, and calculates the rate of the occurrence of the error based on Equation (1) and Equation (2).

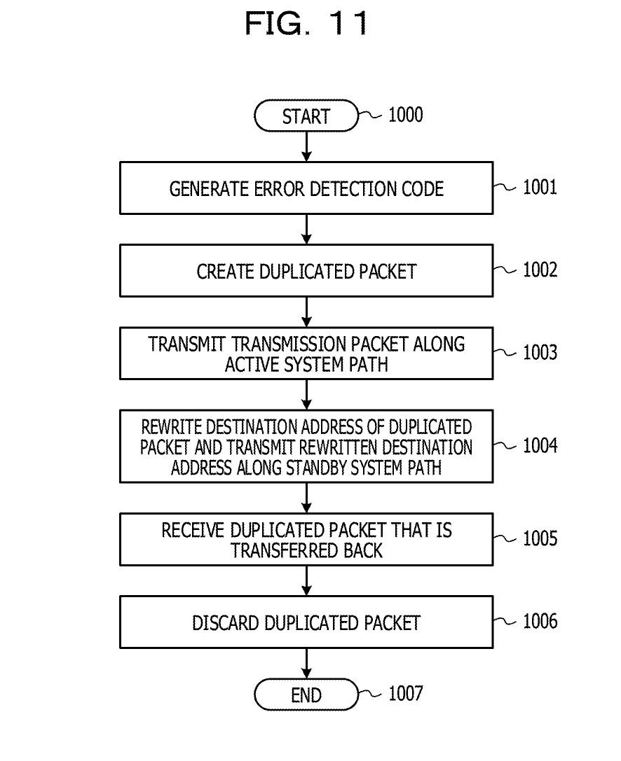

FIG. 11 is a flowchart illustrating processing by the NIC according to the first embodiment, and a flowchart illustrating processing by the NIC 10 relating to packet transmission and reception. Processing in FIG. 11 starts from Processing 1000. In Processing 1001, the error detection code generation unit 112 generates the error detection code based on the transmission data XX that is included in the payload of the transmission packet, and attaches the generated error detection code to the transmission packet. In Processing 1002, the packet generation unit 113 duplicates the transmission packet to which the error detection code is attached, and generates the duplicated packet that includes the payload which has the same data XX as in the transmission packet. In Processing 1003, the device driver A121a transmits the transmission packet to the network switch 2 through the port A101a. In Processing 1004, the address setting unit 122b of the device driver B121b writes the destination address and the transmission source address of the duplicated packet to the address B that is the MAC address of the port B101b, and transmits the destination address and the transmission source address to the network switch 2 through the port B101b, with the destination address and the transmission source address being written to the address B. Because the destination address of the duplicated packet designates the port B101b, the network switch 2 transfers the duplicated packet back to the port B101b. In Processing 1005, the device driver B121b receives the duplicated packet that is transferred back. In Processing 1006, the packet discarding unit 223 discards the duplicated packet that is transferred back from the network switch 2 and the processing ends in Processing 1007.

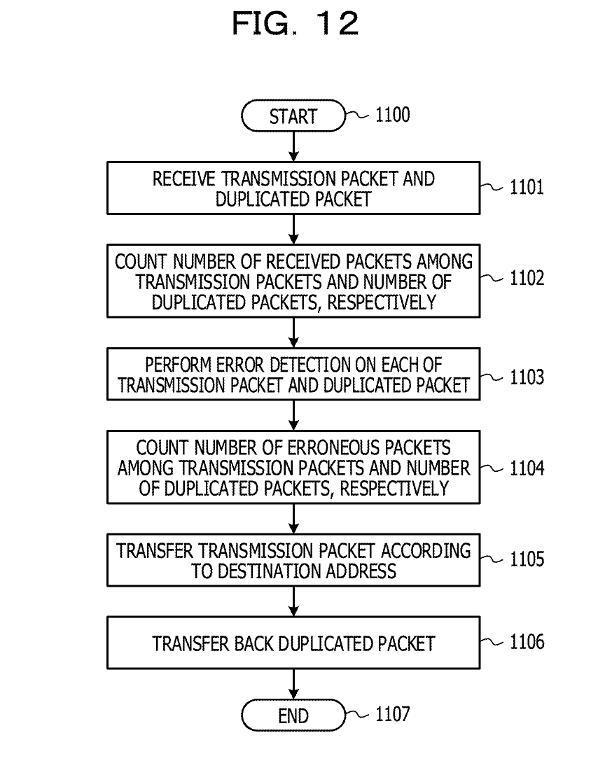

FIG. 12 is a flowchart illustrating processing by the network switch according to the first embodiment, and a flowchart illustrating processing relating to packet transfer by the network switch 2. Processing in FIG. 12 starts from Processing 1100. In Processing 1101, the device driver A′211a and the device driver B′211b receive the transmission packet and the duplicated packet, respectively. In Processing 1102, the number-of-received-packets counter units 214a and 214b count the number of received packets, among the transmission packets and the duplicated packets, respectively. In Processing 1103, the error detection units 212a and 212b perform the error detection on the transmission packet and the duplicated packet, respectively. In Processing 1104, the number-of-erroneous packets counter units 213a and 213b count the number of erroneous packets, among the transmission packets and the duplicated packets, respectively. In Processing 1105, the switch unit 221 transfers the transmission packet according to the designated destination address. In Processing 1106, the switch unit 221 transfers the duplicated packet back to the port B101b and the processing ends in Processing 1107.

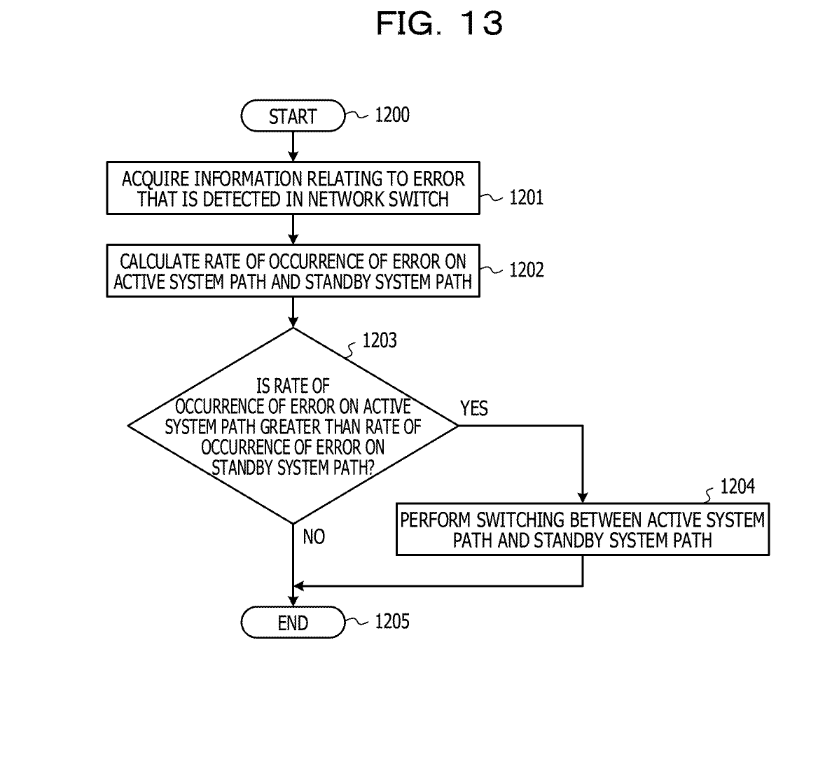

FIG. 13 is a flowchart illustrating the processing by the NIC according to the first embodiment, and a flowchart illustrating the processing by the NIC 10 relating to the switching between the currently-in-use system path and the standby system path. Processing in FIG. 13 starts from Processing 1200. In Processing 1201, the rate-of-error-occurrence calculation unit 115 acquires a counter value from each of the number-of-erroneous packets counter units 213a and 213b and the number-of-received-packets counter units 214a and 214b of the network switch 2. In Processing 1202, the rate-of-error-occurrence calculation unit 115 calculates the rate of the occurrence of the error based on the acquired counter values. The calculation of the rate of the occurrence of the error is performed on each of the communication path A and the communication path B. In Processing 1203, the rate-of-error-occurrence comparison unit 116 compares the rates of the occurrence of the error on the communication path A and the communication path B with each other. In Processing 1203, in a case where the rate of the occurrence of the error on the communication path A in the currently-in-use system is greater than the rate of the occurrence of the error on the communication path B in the standby system (Yes in Processing 1203), proceeding to Processing 1204 takes place. In Processing 1204, the teaming control unit 114 performs control in such a manner that the switching between the currently-in-use system path and the standby system path is performed, that is, in such a manner that the communication path B is used as the currently-in-use system path and the communication path A is used as the standby system path. In Processing 1203, in a case where the rate of the occurrence of the error on the communication path A in the currently-in-use system is the same as or smaller than the rate of the occurrence of the error on the communication path B in the standby system (No in Processing 1203), the processing ends in Processing 1205 without performing the switching between the currently-in-use system path and the standby system path.

In this manner, according to the first embodiment, the duplicated packet that includes the payload which includes the same data as in the transmission packet that is transmitted using the communication path for the currently-in-use system is transmitted using the communication path for the standby system, and the rates of the occurrence of the error on both the communication paths are compared with each other. Because the contents of the pieces of data that are transmitted on both the communication paths are the same, the comparison of the rates of the occurrence of the error is suitably performed without being influenced by the dependence of the rate of the occurrence of the error on the data pattern. The path on which the rate of the occurrence of the error is lower is set as the communication path for the currently-in-use system based on a result of the comparison of the rates of the occurrence of the error, and thus the communication quality is improved. Furthermore, because the destination address of the duplicated packet is set to the address of the port to which the duplicated packet is transmitted and thus the duplicated packet is transferred back to the transmission source from the network switch 2 and discarded without flowing into the network 3, an influence on the transfer rate of different packet communication is suppressed from being exerted.

Moreover, in FIG. 13, the example in which the switching between the paths is performed in the case where the rate of the occurrence of the error on the currently-in-use system path is greater than the rate of the occurrence of the error on the standby system path is described, but the switching between the paths may be performed in a case where the rate of the occurrence of the error on the currently-in-use system path is greater by a predetermined value or above than the rate of the occurrence of the error on the standby system path. The frequency with which a switching operation is performed is suppressed by suitably controlling the predetermined value.

Furthermore, in a case where, like an error correction code (ECC), a code for performing correction on the detected error is used as the error detection code, when it comes to the counting of the number of erroneous packets, the total number of packets in which the error is detected may be counted, and the number of packets on which error correction is impossible to perform may be counted among the packets in which the error is detected.

### Second Embodiment

FIG. 13 illustrates the example in which the switching between the currently-in-use system path and the standby system path is performed in a case where the rate of the occurrence of the error on the currently-in-use system path is greater than the rate of the occurrence of the error on the standby system path. A second embodiment is based on the contents that are disclosed in the first embodiment. In the second embodiment, a condition that the rate of the occurrence of the error on the currently-in-use system exceeds a predetermined threshold that is set is added as a condition for performing the switching between the communication paths. To be more precise, according to the second embodiment, if the rate of the occurrence of the error on the currently-in-use system path, although greater than the rate of the occurrence of the error on the standby system path, continues to be used as the communication path and still falls within a suitable range, the switching between the currently-in-use system path and the standby system path is not performed. Accordingly, the frequency with which a communication path switching operation takes place is suppressed.

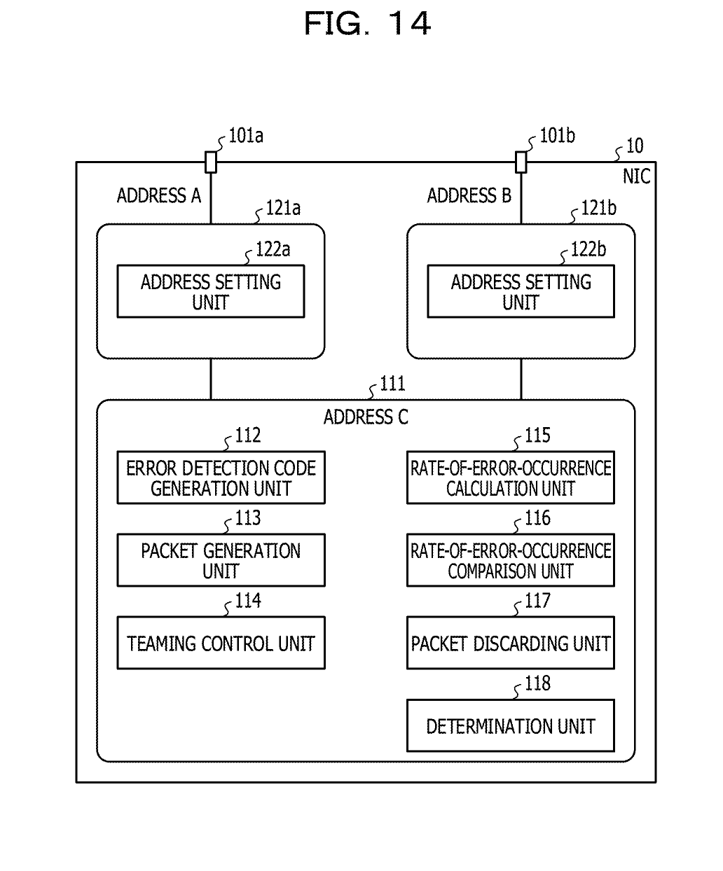

FIG. 14 is a functional block diagram illustrating an NIC 10 according to the second embodiment. In FIG. 14, the same function as that in terms of the contents that are described according to the first embodiment is the same numeral reference and a description thereof is omitted. The NIC 10 further has a determination unit 118. The determination unit 118 determines whether or not the rate of the occurrence of the error on the currently-in-use system path increases and thus exceeds a predetermined threshold that is set. In a case where the determination unit 118 determines that the rate of the occurrence of the error on the currently-in-use system path exceeds the threshold, the rate-of-error-occurrence comparison unit 116 compares the rate of the occurrence of the error on the currently-in-use system path and the rate of the occurrence of the error on the standby system path with each other, and determines whether or not the switching between the communication paths is demanded. The threshold for the rate of the occurrence of the error may be stored, as a fixed value, in the determination unit 118, and may be set by a user through the input device interface 14.

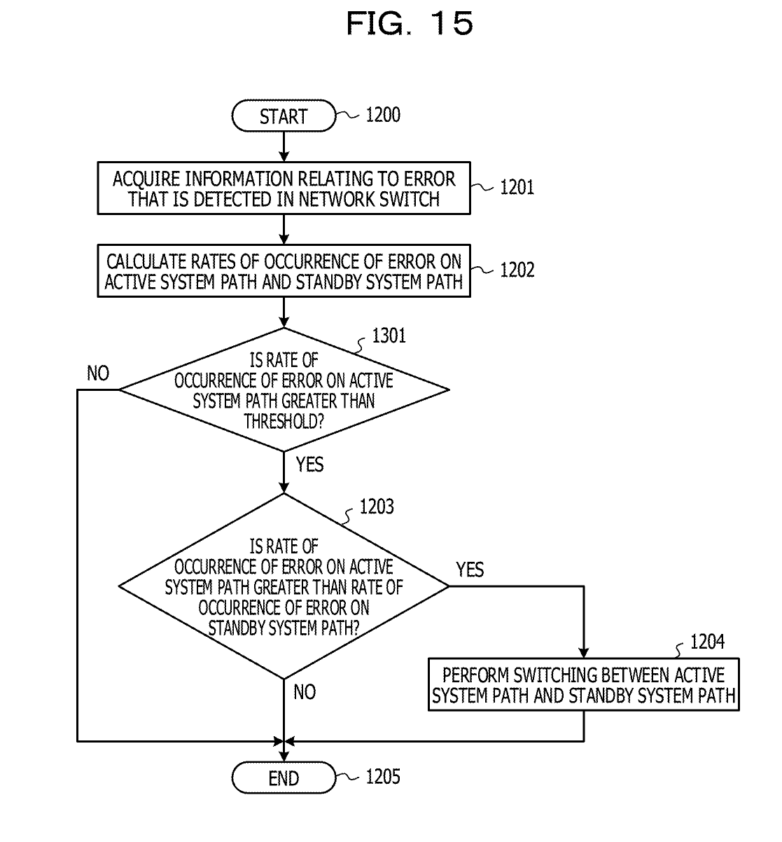

FIG. 15 is a flowchart illustrating processing by the NIC according to the second embodiment, and a flowchart illustrating processing by the NIC 10 relating to the switching between the currently-in-use system path and the standby system path. In FIG. 15, the same processing of which the contents are the same as the contents of the processing that are described referring to FIG. 13 is the same numeral reference, and a description thereof is omitted. After Operation 1202, in Processing 1301, the determination unit 118 compares the rate of the occurrence of the error on the currently-in-use system path and the threshold that is set, with each other. In a case where it is determined in Processing 1301 that the rate of the occurrence of the error on the currently-in-use system path is greater than the threshold (Yes in Processing 1301), proceeding to Processing 1203 takes place. In a case where it is determined in Processing 1301 that the rate of the occurrence of the error on the currently-in-use system path is the same as or smaller than the threshold (No in Processing 1301), the processing ends in Processing 1205 without performing the switching between the communication paths.

In this manner, according to the second embodiment, when the switching between the currently-in-use system path and the standby system path is performed, in addition to comparing the rates of the occurrence of the error on both the communication paths with each other, it is determined whether or not the rate of the occurrence of the error on the currently-in-use system path exceeds the threshold that is set. Accordingly, because control is performed in such a manner that, in a case where the rate of the occurrence of the error on the currently-in-use system path does not exceed the threshold, the switching between the communication paths is not performed, the frequency with which the communication path switching operation takes place is suppressed.

Moreover, a modification example of the flowchart that is illustrated in FIG. 15, in a case where the comparison of the rate of the occurrence of the error on the currently-in-use system path and the rate of the occurrence of the error on the standby system path with each other is performed in advance and where the rate of the occurrence of the error on the currently-in-use system path is greater than the rate of the occurrence of the error on the standby system path, the order of the processing may be changed in such a manner that the determination unit 118 determines whether or not the rate of the occurrence of the error on the currently-in-use system path exceeds the threshold.

### Third Embodiment

According to the first embodiment, the rate of the occurrence of the error on the currently-in-use system path and the rate of the occurrence of the error on the standby system path are calculated using only the packet that is transmitted from the NIC 10 to the network switch 2. According to a third embodiment, the rate of the occurrence of the error on the currently-in-use system path and the rate of the occurrence of the error on the standby system path are calculated with the packet transferred from the network switch 2 to the NIC 10 also being involved, based on the contents that are disclosed in the first embodiment.

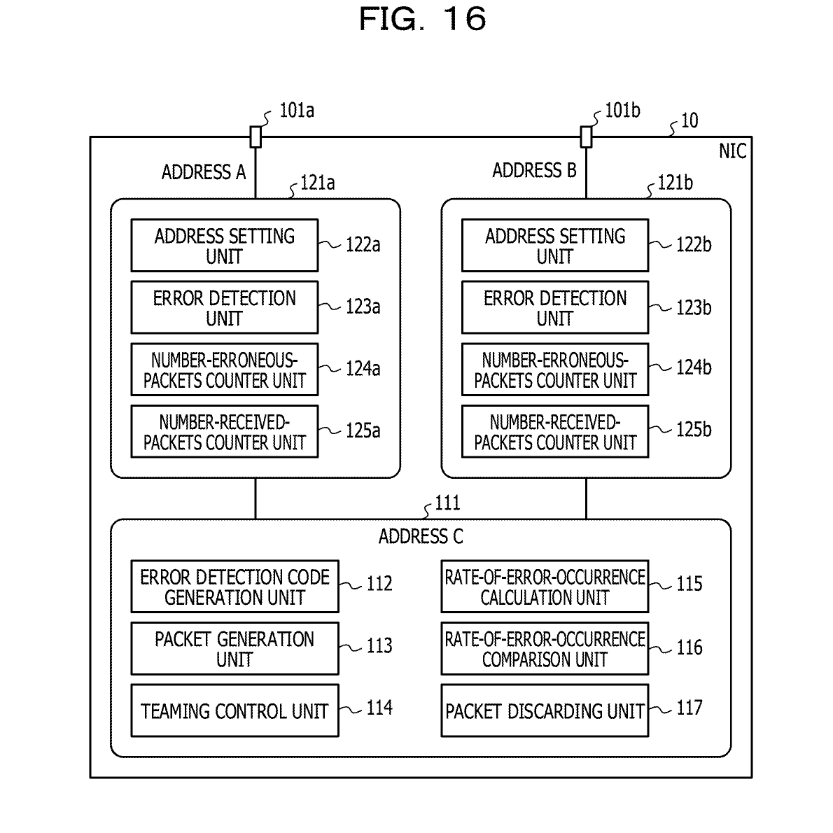

FIG. 16 is a functional block diagram illustrating the NIC 10 according to the third embodiment. In FIG. 16, the same function as that in terms of the contents that are described according to the first embodiment is the same numeral reference and a description thereof is omitted. The processor 110 of the NIC 10 functions as error detection units 123a and 123b, number-of-erroneous-packets counter units 124a and 124b, and number-of-received-packets counter units 125a and 125b with respect to each of the port A101a and the port B101b. The error detection units 123a and 123b perform the error detection using the error detection code that is included in the packet which is received from the network switch 2. The number-of-erroneous-packets counter units 124a and 124b count the number of packets in which the errors are detected by the error detection units 123a and 123b, respectively. The number-of-received-packets counter units 125a and 125b count the total number of packets that are received from the network switch 2. Moreover, for the NIC 10, these functions may be realized using a dedicated logic circuit.

According to the third embodiment, the rate of the occurrence of the error is calculated using the number of erroneous packets and the number of received packets that are acquired by the NIC 10, as well as the number of erroneous packets and the number of received packets that are acquired by the network switch 2. The rate of the occurrence of the error according to the third embodiment is calculated as follows.

A rate ER_A2 of the occurrence of the error on the communication path A and a rate ER_B2 of the occurrence of the error on the communication path B are expressed by the following Equation (3) and Equation (4), where the total number of packets that are transmitted from the network switch 2 to the NIC 10 using the communication path A is rxA2, the number of packets in which the error is detected among the packets that are transmitted along the communication path A is crcA2, the total number of packets that are transmitted from the network switch 2 to the NIC 10 using the communication path B is rxB2, and the number of packets in which the error is detected among the packets that are transmitted along the communication path B is crcB2.

ER_A2=(crcA1+crcA2)/(rxA1+rxA2) (3)

ER_B2=(crcB1+crcB2)/(rxB1+rxB2) (4)

At this point, the packet that is received along the currently-in-use system path is a packet that is transferred from a different information processing apparatus or the like with the information processing apparatus 1 as a destination, and the packet that is received along the standby system path is a duplicated packet that is sent from a standby system port and is transferred back. The rate-of-error-occurrence calculation unit 115 of the NIC 10 acquires rxA1 and rxB1 from the number-of-received-packets counter units 214a and 214b of the network switch 2, acquires crcA1 and crcB1 from the number-of-erroneous packets counter units 213a and 213b of the network switch 2, acquires rxA2 and rxB2 from the number-of-received-packets counter units 125a and 125b of the NIC 10, and acquires crcA2 and crcB2 from the number-of-erroneous-packets counter units 124a and 124b of the NIC 10, and thus calculates the rate of the occurrence of the error using Equation (3) and Equation (4). Then, in the same manner as in the first embodiment, the rate-of-error-occurrence comparison unit 116 compares the currently-in-use system path and the rate of the occurrence of the error on the standby system path with each other, and determines whether or not the switching between the communication paths is demanded.

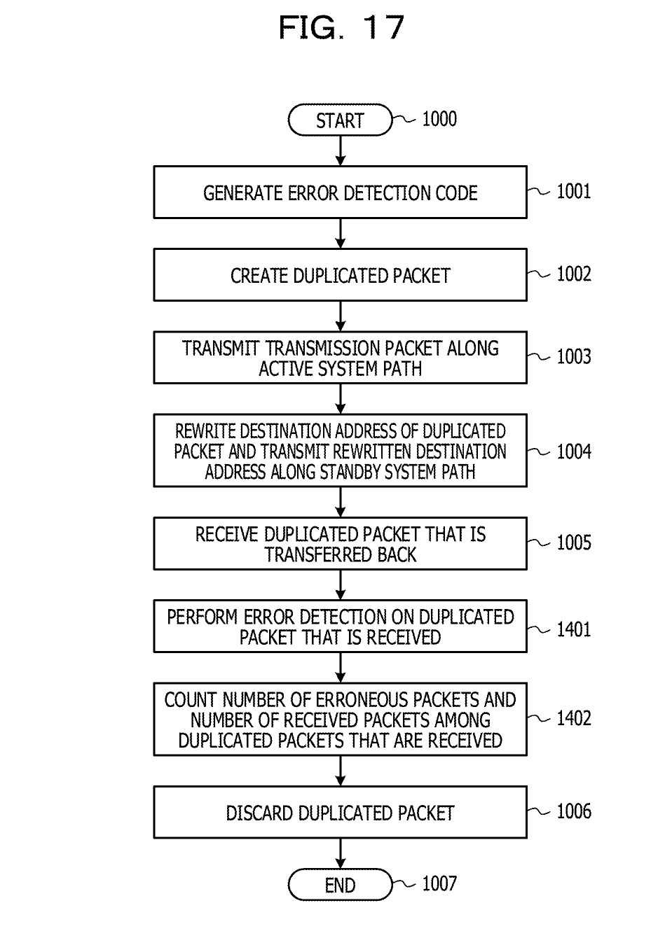

FIG. 17 is a flowchart illustrating processing by the NIC according to the third embodiment and a flowchart illustrating processing by the NIC 10 relating to the packet transmission. In FIG. 17, the same processing of which the contents are the same as the contents of the processing that are described referring to FIG. 11 is the same numeral reference, and a description thereof is omitted. After Processing 1005, in Processing 1401, the error detection unit 123b performs the error detection on the duplicated packet that is transferred back from the network switch 2. In Processing 1402, the number-of-erroneous-packets counter unit 124b and the number-of-received-packets counter unit 125b count the number of erroneous packets and the number of received packets, respectively, among the duplicated packets. Moreover, although not illustrated in FIG. 17, in a case where the packet is transmitted from a different information processing apparatus with the information processing apparatus 1 as the destination, the error detection unit 123a performs the error detection, and the number-of-erroneous-packets counter unit 124a and the number-of-received-packets counter unit 125a count the number of erroneous packets and the number of received packets, respectively.

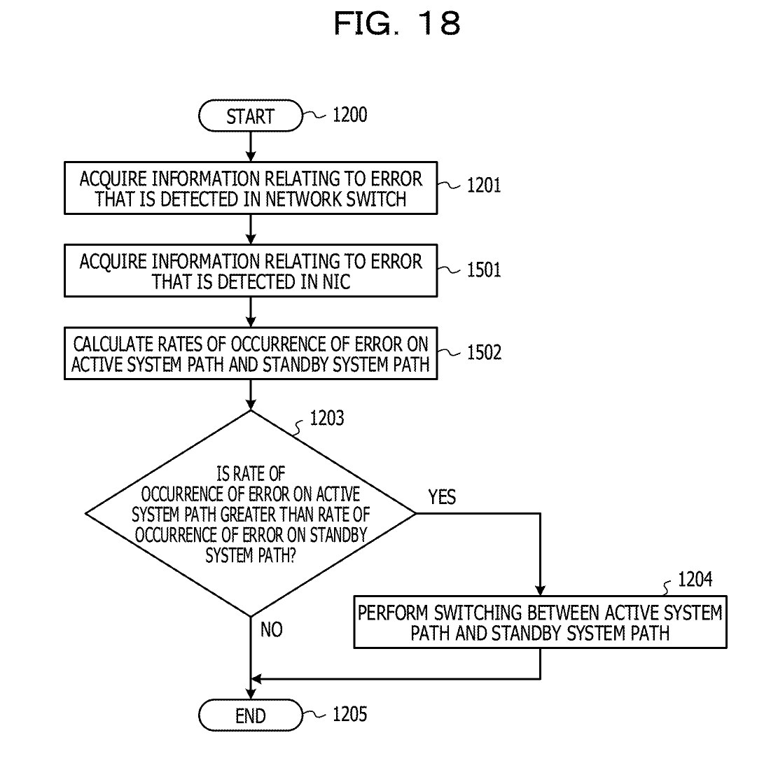

FIG. 18 is a flowchart illustrating the processing by the NIC according to the third embodiment and a flowchart illustrating the processing by the NIC 10 relating to the switching between the communication paths. In FIG. 18, the same processing contents as in FIG. 13 are given the same numeral references and descriptions thereof are omitted. In Processing 1501, the rate-of-error-occurrence calculation unit 115 acquires the number of erroneous packets and the number of received packets, from each of the number-of-erroneous-packets counter units 124a and 124b, the number-of-erroneous packets counter units 213a and 213b, the number-of-received-packets counter units 125a and 125b, and the number-of-received-packets counter units 214a and 214b. In Processing 1502, the rate-of-error-occurrence calculation unit 115 calculates the rates of the occurrence of the error on both the currently-in-use system path and the standby system path, with both the packet that is transmitted from the NIC 10 to the network switch 2 and the packet that is transmitted from the network switch 2 to the NIC 10 being involved.

According to the third embodiment, the calculation of the rate of the occurrence of the error on each communication path is performed with the packet transferred from the network switch 2 to the NIC 10 also being involved. The packet that is transmitted from the NIC 10 to the network switch 2 is data that contains the same contents as already described, but the packet that is transferred from the network switch 2 to the NIC 10 is not limited to the data that contains the same contents. However, in a case where the transfer from the network switch 2 to the NIC 10 is not also considered in the calculation of the rate of the occurrence of the error, a technique according to the present embodiment is effective. Moreover, the third embodiment may be combined with the second embodiment, and thus the condition that the rate of the occurrence of the error on the currently-in-use system exceeds the predetermined threshold may be added as the condition for performing the switching between the communication paths.

### Fourth Embodiment

According to the first or second embodiment, the duplicated packet is described as being discarded after being transferred back to the port that is the transmission source, but the duplicated packet may be discarded without being transferred back to the port that is the transmission source. According to a fourth embodiment, a mode in which the duplicated packet is discarded in the network switch 2 is described.

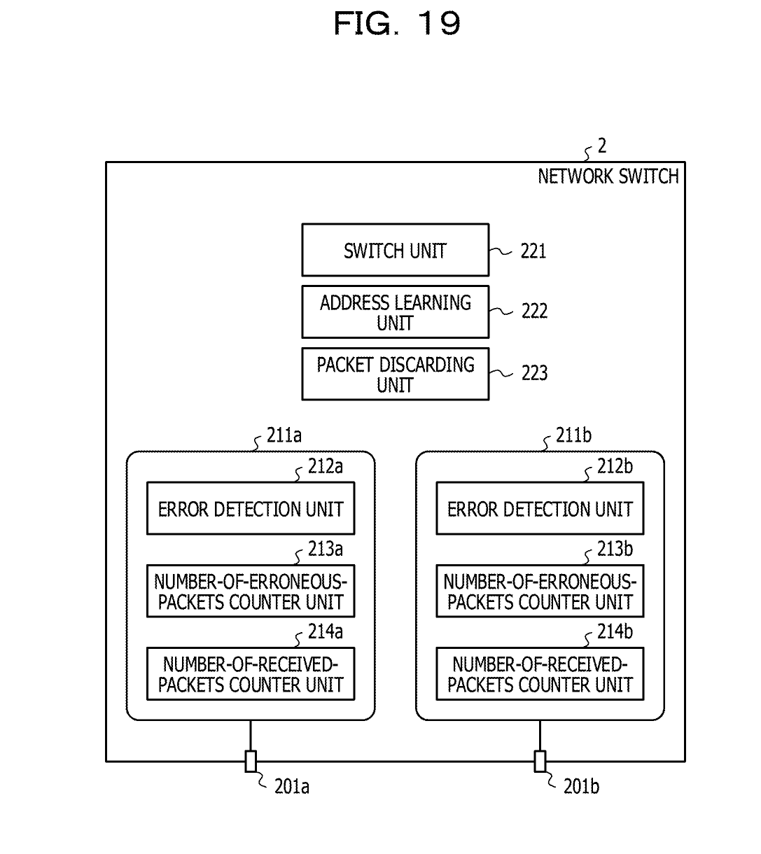

FIG. 19 is a functional block diagram illustrating a network switch according to the fourth embodiment, and a functional block diagram illustrating a network switch 2 according to the fourth embodiment. In FIG. 19, the same functional block as the functional block that is described referring to FIG. 10 is given the same numeral reference, and a description thereof is omitted. The network switch 2 further has the packet discarding unit 223. The packet discarding unit 223 discards the duplicated packet that is received along the standby system path, and thus keeps the duplicated packet from being sent to the network 3. As a method in which the received packet is recognized as the duplicated packet and discarded, for example, there is a method in which the packet discarding unit 223 recognizes the packet of which the destination address and the transmission source address are the same, as the duplicated packet, and discards the packet that is recognized as the duplicated packet. As illustrated in FIG. 8B, in the duplicated packet, any one of the destination address and the transmission source address is the port B101b on the standby system path B. Consequently, the packet discarding unit 223 recognizes the packet of which the destination address and the transmission source address are the same, as the duplicated packet, and discards the packet that is recognized as the duplicated packet. Furthermore, as a different method in which the duplicated packet is recognized, there is a method in which the NIC 10 attaches a discarding flag to the duplicated packet. For example, when the packet generation unit 113 generates the duplicated packet, a discarding flag indicating that the generated packet is the duplicated packet and thus is a packet that has to be discarded is generated, and the discarding flag is transmitted in a state of being attached to the packet. In a case where the discarding flag is attached to the received packet, the packet discarding unit 223 recognizes the received packet as the duplicated packet, and discards the received packet. Accordingly, the duplicated packet is discarded without being transferred back to the transmission source.

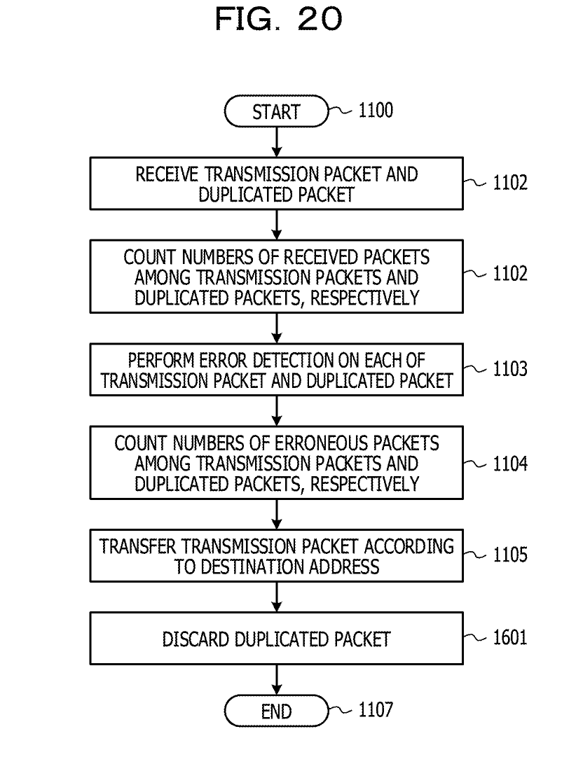

FIG. 20 is a flowchart illustrating processing by the network switch 2 according to the fourth embodiment. In FIG. 20, the same processing contents as in FIG. 12 are given the same numeral references and descriptions thereof are omitted. In Processing 1601, the packet discarding unit 223 discards the duplicated packet, and the processing ends in Processing 1107.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system comprising:
a network switch configured to transfer a received packet; and
an information processing apparatus including a communication interface circuit and a processor, the communication interface circuit being coupled to the network switch through a first communication path and a second communication path,
wherein
the processor is configured to:
transmit a first packet including a first payload to the network switch using the first communication path,
transmit the second packet to the network switch using the second communication path, the second packet including a second payload of the second packet in which the same information as information recorded in the first payload of the first packet is recorded,
an error detection is executed with regard to information respectively recorded in the first payload of the first packet and the second payload of the second packet.

2. The system according to claim 1, wherein the processor is configured to:
compare a rate of occurrence of an error on the first communication path and a rate of occurrence of an error on the second communication path with each other.

3. The system according to claim 2, wherein the processor is configured to:
control one with a lower rate of the occurrence of the error, of the first communication path and the second communication path, as an active system path among the active system path and a standby system path based on the comparison.

4. The system according to claim 1, wherein
the communication interface circuit includes a first port configured to couple to the first communication path and a second port configured to couple to the second communication path,
the second port is set as a destination of the second packet,
the network switch is configured to transmit the second packet to the second port, and
the second packet transmitted from the network switch is discarded in the information processing apparatus.

5. The system according to claim 4, wherein the second port is set as a transmission source address of the second packet.

6. The system according to claim 1, wherein in the information processing apparatus, a code for detecting the error is attached to the first packet and the second packet.

7. An information processing apparatus comprising:
a communication interface circuit configured to couple to a network switch configured to transfer a received packet through a first communication path and a second communication path; and
a processor coupled to the communication interface circuit and configured to:
create a first packet including a first payload,
create a second packet including a second payload in which the same information as information recorded in the first payload of the first packet is recorded, and
execute a first device driver program for transmitting the first packet to the network switch using the first communication path, and a second device driver program for transmitting the second packet to the network switch using the second communication path.

8. The information processing apparatus according to claim 7, wherein the processor is configured to:
compare a rate of occurrence of an error on the first communication path and a rate of occurrence of an error on the second communication path with each other.

9. The information processing apparatus according to claim 8, wherein the processor is configured to:
control one with a lower rate of the occurrence of the error, of the first communication path and the second communication path, as an active system path among the active system path and a standby system path based on the comparison.

10. The information processing apparatus according to claim 7, wherein
the communication interface circuit includes a first port configured to couple to the first communication path and a second port configured to couple to the second communication path,
the second port is set as a destination of the second packet,
the network switch is configured to transmit the second packet to the second port, and
after the second packet is transmitted from the network switch to the second port, the second packet is discarded in the information processing apparatus.

11. The information processing apparatus according to claim 10, wherein the second port is set as a transmission source address of the second packet.

12. The information processing apparatus according to claim 7, further comprising:
a circuit configured to attach a code for detecting the error to the first packet and the second packet.

13. A method of transmitting data executed by an information processing apparatus, the information processing apparatus including a communication interface circuit and a processor coupled, the communication interface circuit being coupled to a network switch through a first communication path and a second communication path, the network switch configuring to transfer a received packet, the method comprising:
transmitting a first packet including a first payload to the network switch using the first communication path; and
transmitting the second packet to the network switch using the second communication path, the second packet including a second payload of the second packet in which the same information as information recorded in the first payload of the first packet is recorded,
wherein an error detection is executed with regard to information respectively recorded in the first payload of the first packet and the second payload of the second packet by the network switch.

14. The method according to claim 13, further comprising:
compare a rate of occurrence of an error on the first communication path and a rate of occurrence of an error on the second communication path with each other.

15. The method according to claim 14, further comprising:
controlling one with a lower rate of the occurrence of the error, of the first communication path and the second communication path, as an active system path among the active system path and a standby system path based on the comparison.

16. The method according to claim 13, wherein
the communication interface circuit includes a first port configured to couple to the first communication path and a second port configured to couple to the second communication path,
the second port is set as a destination of the second packet, and
the network switch is configured to transmit the second packet to the second port, and
the method further comprising:
discarding the second packet transmitted from the network switch.

17. The method according to claim 16, wherein the second port is set as a transmission source address of the second packet.

18. The method according to claim 13, further comprising:
attaching a code for detecting the error to the first packet and the second packet.
